(19) United States
(12) Patent Application Publication
(10) Pub. No.: US 2020/0205351 A1
(43) Pub. Date: Jul. 2, 2020

(54) INTEGRATED STAIR GARDEN

(71) Applicant: Urban Gardener LLC, Philadelphia, PA (US)

(72) Inventor: Jared C. Leon, Philadelphia, PA (US)

(21) Appl. No.: 16/237,242

(22) Filed: Dec. 31, 2018

(51) Int. Cl. A01G 9/02; A01G 27/00

(52) U.S. Cl. CPC A01G 9/023; A01G 27/003

(57) ABSTRACT

An integrated stair planter to provide a plurality of levels for plants to be grown in areas where room is limited. Each of the levels enables various types of plants to be planted at any location. Each of the levels are in communication with one another for providing more efficient watering and drainage. The integrated planter includes side panels having a plurality of steps along an upper edge and a sloped lower edge, a plurality of risers to connect between associated risers of the side panels, a sloped floor to seal off an underside of the integrated planter and connect to the sloped lower edge of each of the side panels. A plurality of step planters are provided between associated treads of the side panels and abutting risers. An integrated opening is formed by the plurality of step planters as the step planters are connected to one another.

### BACKGROUND

Many people enjoy plants and/or gardens in their yards and/or in their homes. Some homes only have small yards, or do not have yards. These types of homes do not provide the homeowners with the ability to have a large garden and/or to have a lot of plants. These types of homes may utilize plant hangers and/or plant stands to provide a means for having plants and/or gardens. Plant hangers and/or plant stands are limited in the number and type of plants that may be supported. Furthermore, plant hangers and/or plant stands do not provide the ability for integrated irrigation between all the plants.

What is needed is a planting system that provides the ability to house a variety of plants in locations with limited space. The planting system should also provide the ability to irrigation for all the plants located therein from a single location.

### BRIEF DESCRIPTION OF THE DRAWINGS

The features and advantages of the various embodiments will become apparent from the following detailed description in which:

FIGS. 1A-D illustrate perspective views of example integrated stair gardens, according to several embodiments;

FIG. 2 illustrates an exploded perspective view of an example integrated stair garden, according to one embodiment;

FIG. 3 illustrates a perspective view of the example integrated stair garden of FIG. 2 assembled, according to one embodiment.

FIG. 4 illustrates a perspective view of the example integrated stair garden of FIG. 2 with plants located therein, according to one embodiment;

FIGS. 5A-C illustrate perspective views of several embodiments of an example integrated stair garden having drainage along a lower section, according to several embodiments;

FIGS. 6A-C illustrate perspective views of several embodiments of an example integrated stair garden having posts or the like that extend above the steps according to several embodiments; and

FIG. 7 illustrates a perspective view of an example integrated stair garden having watering enabled within the device, according to one embodiment.

### DETAILED DESCRIPTION

The current invention is an integrated stair planter that enables plants to be grown in areas where room is limited. The integrated stair planter provides for a plurality of levels for plants to be planted. Each of the levels enables various types of plants to be planted at any location. Furthermore, each of the levels are in communication with one another for providing more efficient irrigation (e.g., watering and drainage). The stair planter is designed to be self-contained and self-supporting and to provide elevated levels for plants.

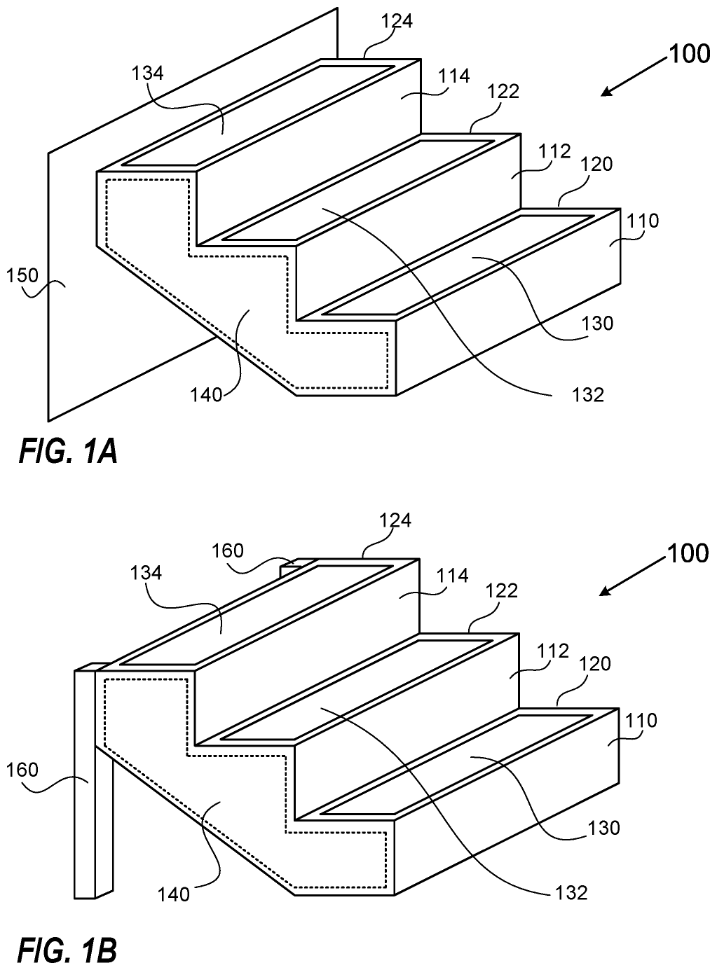

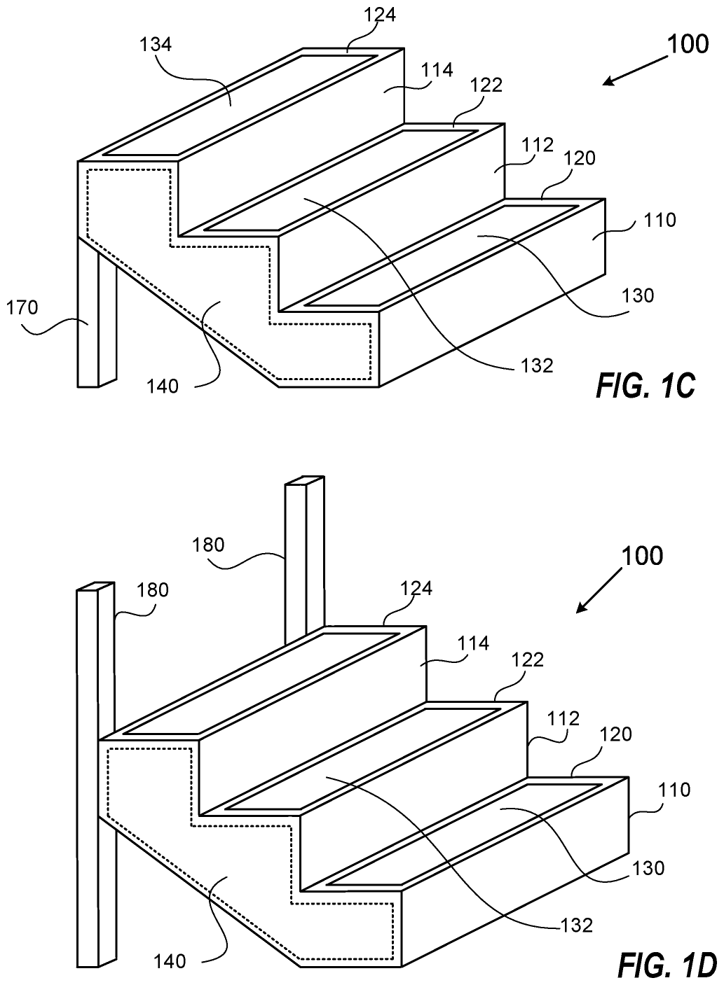

FIGS. 1A-D illustrate perspective views of several embodiments of an example integrated stair garden 100. The integrated stair garden 100 includes a plurality of steps (e.g., three illustrated) having risers 110, 112, 114 and treads 120, 122, 124. The treads 120, 122, 124 have openings 130, 132, 134 formed therein for accepting soil and plants. The openings 130, 132, 134 are connected to one another so that there is an integrated opening 140 (as illustrated by the dotted line). The bottom of the stair garden 100 and the integrated opening 140 may be sloped. The slope may assist material to move downward within the stair garden 100 (e.g., move from opening 134 to opening 132 and from opening 132 to opening 130). The material may include, but is not limited to, soil, nutrients and/or water. By way of example, the sloped integrated opening 140 may enable any excess water provided to any of the openings 134, 132, 130 to flow to the bottom of the stair garden 100. According to one embodiment, the stair garden 100 may include some type of drainage at the bottom thereof (to be discussed in more detail later).

As illustrated in FIG. 1A, the stair garden 100 may be secured to a wall 150. The stair garden 100 may be secured to the wall 150 in various manners including, for example, with screws, nails, hook and loop (e.g., Velcro®), glue, tape, adhesive, pins, bolts, rivets, clamps, hooks, brackets or the like. According to one embodiment, the stair garden 100 may simply be leaning against the wall 150. The leaning stair garden 100 may require the front of the stair garden 100 to be secured in some fashion so that it doesn't slide down the wall 150. The front of the stair garden 100 may have objects placed in front of it so that it does not slide away from the wall 150 or it may be mounted to the ground in some fashion (e.g., spikes, ties).

As illustrated in FIGS. 1B-D, the stair garden 100 may include legs to support the upper end thereof so that the stair garden 100 need not be secured to, or leaned against, a wall 150. The use of the legs allows the stair garden 100 to be self-supported/self-standing. FIG. 1B is an embodiment that includes a plurality of legs 160 (2 illustrated, one at each back corner) mounted to the back of the stair garden 100. FIG. 1C is an embodiment that includes a plurality of legs 170 (only one visible at a back corner) mounted to underside of the stair garden 100. FIG. 1D is an embodiment that includes a plurality of legs 180 (2 illustrated, one at each back corner) mounted to the back of the stair garden 100 and protruding upward from the top of the stair garden 100. The legs 180 extending upward from the stair garden 100 can be utilized for any number of reasons including, but not limited to, hanging items such as lights, netting, sensors, gardening tools, hoses and/or other watering means.

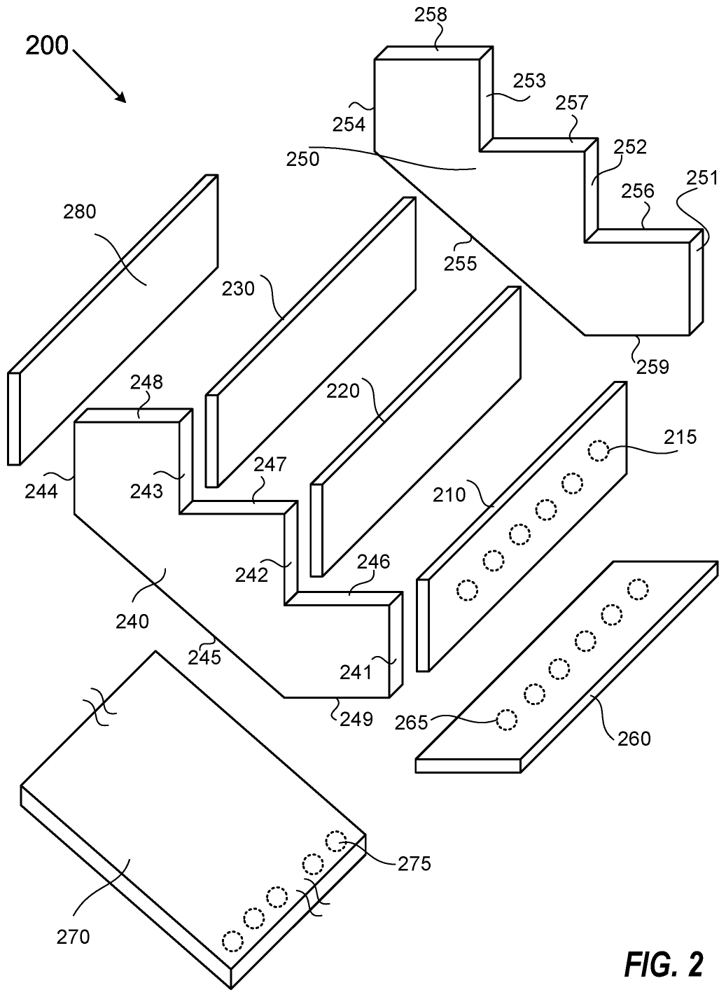

FIG. 2 illustrates an exploded perspective view of an example integrated stair garden 200. The integrated stair garden 200 may include a plurality (3 illustrated) of risers 210, 220, 230, a plurality (2 illustrated) of side panels 240, 250, a plurality of floor panels 260, 270 and a back panel 280. The risers 210, 220, 230 may be substantially identical pieces that have the same height and width so as to provide a standard length and depth planter within the stair garden 200. However, the risers 210, 220, 230 are not limited to having the same dimensions. The floor panels 260, 270 and the back panel 280 may have the same length as the risers 210, 220, 230.

The side panels 240, 250 may be substantially identical pieces that have a plurality (3 illustrated) of risers 241, 242, 243, 251, 252, 253 and a plurality (3 illustrated) of treads 246, 247, 248, 256, 257, 258. The side panels 240, 250 also include a back side 244, 254, a floor 249, 259 and a sloping bottom 245, 255 between the back side 244, 254 and the floor 249, 259. According to one embodiment, each of the risers 241, 242, 243, 251, 252, 253 may have the same height. However, in alternative embodiments the height of the risers 241, 242, 243, 251, 252, 253 may vary to create different height planters. According to one embodiment, each of the treads 246, 247, 248, 256, 257, 258 may have the same depth. However, in alternative embodiments the depth of the treads 246, 247, 248, 256, 257, 258 may vary to create different depth planters. The floor 249, 259 may have the same depth as the treads 246, 256 but is in way limited thereto. Likewise, the back side 244, 254 may have the same height as the risers 243, 253 but is in way limited thereto. The slope of the bottom 245, 255 is dependent on the distance (depth and height) between the back side 244, 254 and the floor 249, 259.

The height of the risers 241, 242, 243, 251, 252, 253 may be the same as the height of the risers 210, 220, 230. The risers 210, 220, 230 may be secured to respective risers 241, 242, 243, 251, 252, 253 of each of the side panels 240, 250. The risers 210, 220, 230 may be secured to the side panels 240, 250 in various means including but not limited to screws, nails, hook and loop (e.g., Velcro®), glue, tape, adhesive, pins, bolts, rivets, clamps, hooks, brackets or the like. The risers 210, 220, 230 and the side panels 240, 250 may be formed so as to able to connect to one another using, for example, tabs and indents. The floor panel 260 may have the same depth as the floor 249, 259 and may be secured thereto in various means such as those noted above. The floor panel 270 may have the same depth as the sloped bottom 245, 255 and may be secured thereto in various means such as those noted above. The back panel 280 may have the same height as the back 244, 254 and may be secured thereto in various means such as those noted above.

According to one embodiment, the stair garden 200 may provide a means for enabling excess water to exit therefrom. As noted above, excess water may flow down the stair garden 200. The stair garden 200 may include holes or the like along lower portions thereof to allow water to exit therefrom. The holes may include mesh, fabric or the like that would allow water to exit therefrom but not soil, stones or the like that may be contained therein. As illustrated, holes 215 may be formed in the riser 210 (e.g., along a lower edge thereof) to allow water to exit from the front of the stair garden 200 (in front of first step). Alternatively, or in addition to, holes 265 may be formed in the bottom panel 260 to enable water to exit the bottom of the stair garden 200. Alternatively, or in addition to, holes 275 may be formed in the bottom panel 270 to enable water to exit the back of the stair garden 200 (behind first step). The number, orientation, location and size of the holes 215, 265, 275 is in no way intended to be limited in any manner.

The various components of the stair garden can be made from a variety of materials. The materials should be capable of handling different weather conditions including hot and cold temperatures, ultraviolet light, and precipitation, as well as insects and animals. The materials should be capable of lasting for a substantial amount of time and not erode, breakdown, decay and/or rust. The materials also should be capable of supporting the weight of the soil and plants that are to be located therein. The materials should be safe for the plants. Preferably the materials should be light weight to allow for easy transportation and set up as well possibly moving the stair garden once configured. According to one embodiment, the materials may be plastic such as Polyvinyl Chloride (PVC), Acrylonitrile-Butadiene-Styrene (ABS), Acrylic or Polymethyl Methacrylate (PMMA), Polycarbonate (PC), Polyethylene (PE), Polypropylene (PP) and/or Polyethylene Terephthalate (PETE or PET). According to one embodiment, the materials may be metals such as tin, aluminum, steel. According to one embodiment the materials may be wood including pressure treated wood.

According to one embodiment, at least some subset of the various components of the stair garden can be collapsed, folded or broken apart into multiple pieces to enable the stair garden to be broken down into a smaller footprint. The smaller footprint enables the stair garden to be more easily transported and displayed. It also enables the stair garden to more easily be moved and stored.

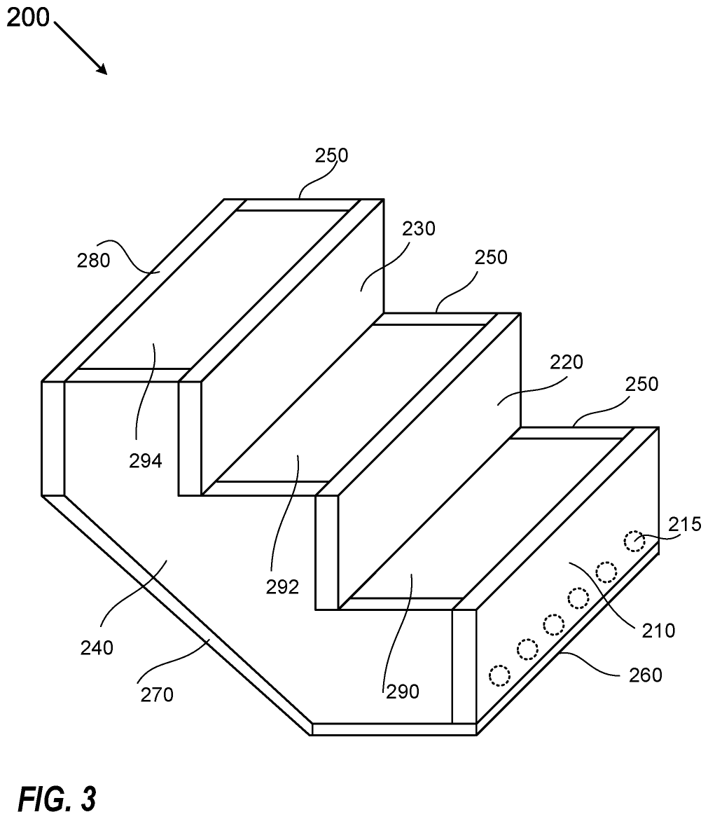

FIG. 3 illustrates a perspective view of the example integrated stair garden 200 assembled. The assembled stair garden 200 includes open treads that create planting sections 290, 292, 294. As previously noted, the planting sections 290, 292, 294 are all connected to one another so as to create an integrated planter (integrated opening 140 illustrated in FIGS. 1A-D). The integrated planter enables water and possibly nutrients to move downward within the stair garden 200 and may enable any excess water to exit at the bottom of the stair garden 200 via the holes 215, 265.

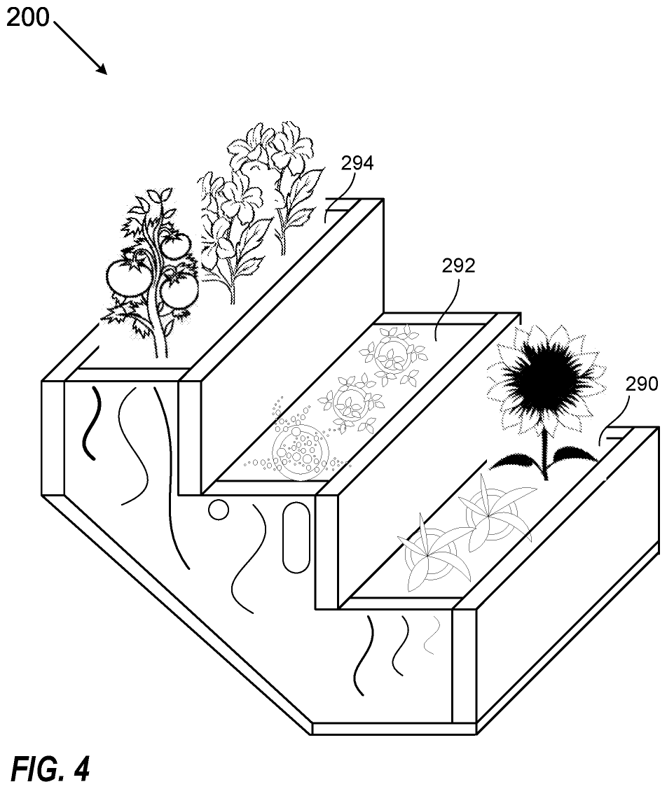

FIG. 4 illustrates a perspective view of the example integrated stair garden 200 with different items planted in the planting sections 290, 292, 294. The different items planted may include various plants, vegetables and/or the like. The various plants that may be planted may have varying root structures (e.g., depth, thickness, orientation). For ease of illustration, the varying root structures are simply illustrated on the side panel (not labeled) as curved lines with the depth of the roots being indicated by the length of the lines, the thickness of the roots by the thickness of the line and the orientation by the curve of the line. Some of the vegetables that may be planted may grow in the soil and the depth, size, shape and orientation of the vegetables may vary. For ease of illustration the varying vegetables are simply illustrated on the side panel as different shapes (circles, ovals). The integrated planter design allows the roots and/or the vegetables to extend below the riser (not labeled in FIG. 4) for the associated planting section 290, 292, 294.

It should be noted that FIGS. 2-4 do not illustrate any legs for simplicity. The stair garden 200 may not include legs or may include any number and type of legs (e.g., 160, 170, 180) without departing from the current scope.

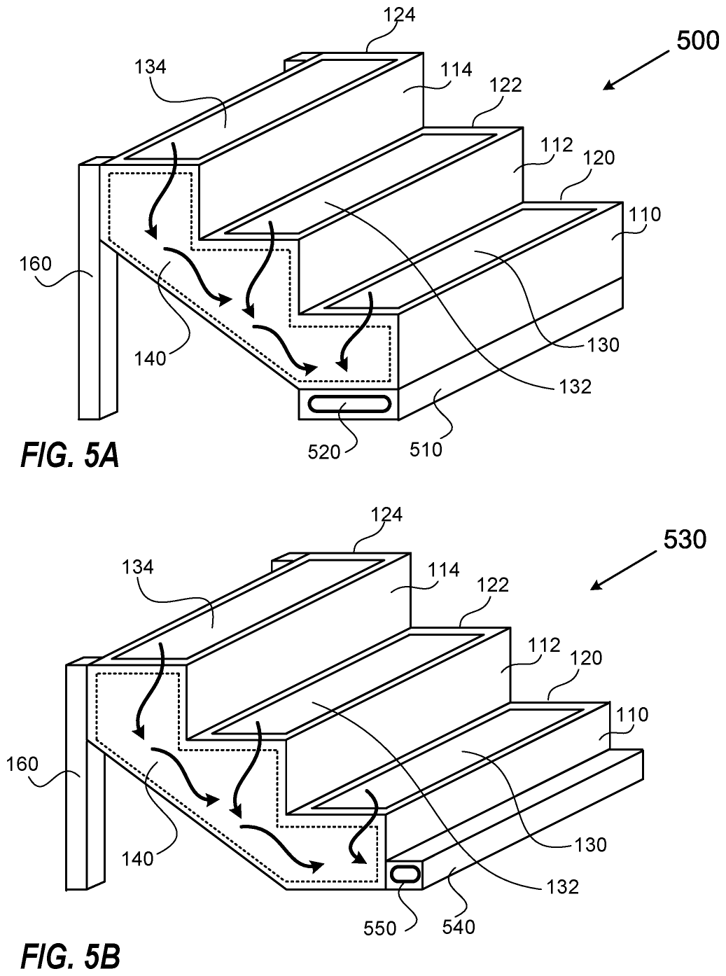

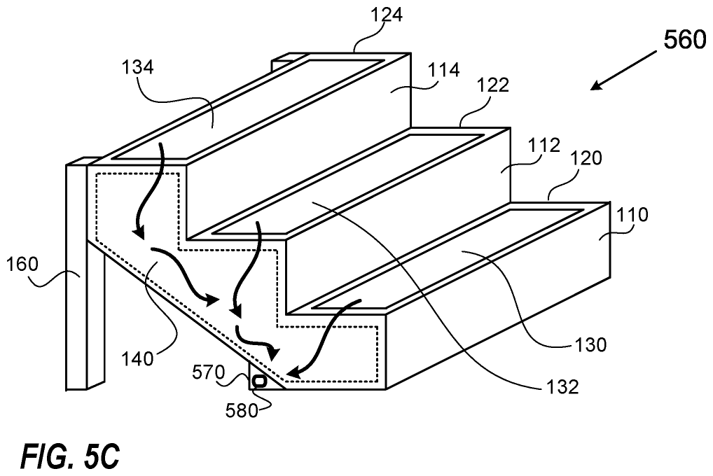

FIGS. 5A-C illustrate perspective views of several embodiments of an example integrated stair garden having drainage along a lower section. The stair gardens illustrated in FIGS. 5A-B are similar to those illustrated in FIGS. 1A-D so similar items are identified with same numbers. FIG. 5A illustrates an embodiment of a stair garden 500 where a drainage capturing device 510 is located below the first step. Excess water may flow from upper portions of the stair garden 500 as indicated by the arrows and be captured in the drainage capturing device 510. Captured water 520 is simply indicated by an oval within the drainage capturing device 510 for ease of illustration. In order for the drainage capturing device 510 to capture the excess water below the first step, the bottom of the first step may include holes formed therein (265 in FIG. 2). The drainage capturing device 510 may simply be a container for catching the excess water that flows from under the step. Alternatively, the drainage capturing device 510 may be an integral part of the stair garden 500 (e.g., may be a drawer located below the step). In order to configure the stair garden 500 to accept the drainage capturing device 510 under the first step, the first step needs to be raised off the ground. This may be accomplished by raising the back of the stair garden 500. The back of the stair garden 500 may be raised by, for example, using a longer post 160 (could be any other post).

FIG. 5B illustrates an embodiment of a stair garden 530 where a drainage capturing device 540 is located in front of the first step. Excess water may flow from upper portions of the stair garden 530 as indicated by the arrows and be captured in the drainage capturing device 540. Captured water 550 is simply indicated by an oval within the drainage capturing device 540 for ease of illustration. In order for the drainage capturing device 540 to capture the excess water in front of the first step, the front of the first step may include holes formed therein (215 in FIGS. 2 and 3). The drainage capturing device 540 may simply be a container for catching the excess water that flows out of the front of the first step. Alternatively, the drainage capturing device 540 may be an integral part of the stair garden 530 (e.g., may be a trough located in front of the step).

FIG. 5C illustrates an embodiment of a stair garden 560 where a drainage capturing device 570 is located behind the first step. Excess water may flow from upper portions of the stair garden 560 as indicated by the arrows and be captured in the drainage capturing device 570. Captured water 580 is simply indicated by an oval within the drainage capturing device 580 for ease of illustration. In order for the drainage capturing device 570 to capture the excess water behind the first step, the sloped bottom may include holes formed therein close to the first step (275 in FIG. 2). The drainage capturing device 570 may simply be a container for catching the excess water that flows out behind the first step. Alternatively, the drainage capturing device 570 may be an integral part of the stair garden 530 (e.g., may be a trough located behind the step).

FIGS. 5A-C simply illustrated drainage collection devices 510, 540, 570 that collect the excess water 520, 550, 580. The drainage collection devices 510, 540, 570 may be removable so that the excess water 520, 550, 580 may be disposed of or recycled (provided back to the stair garden 500, 530, 560). According to one embodiment, the stair garden 500, 530, 560 may include a pump (not illustrated) that may rout the excess water back one or more of the planter sections.

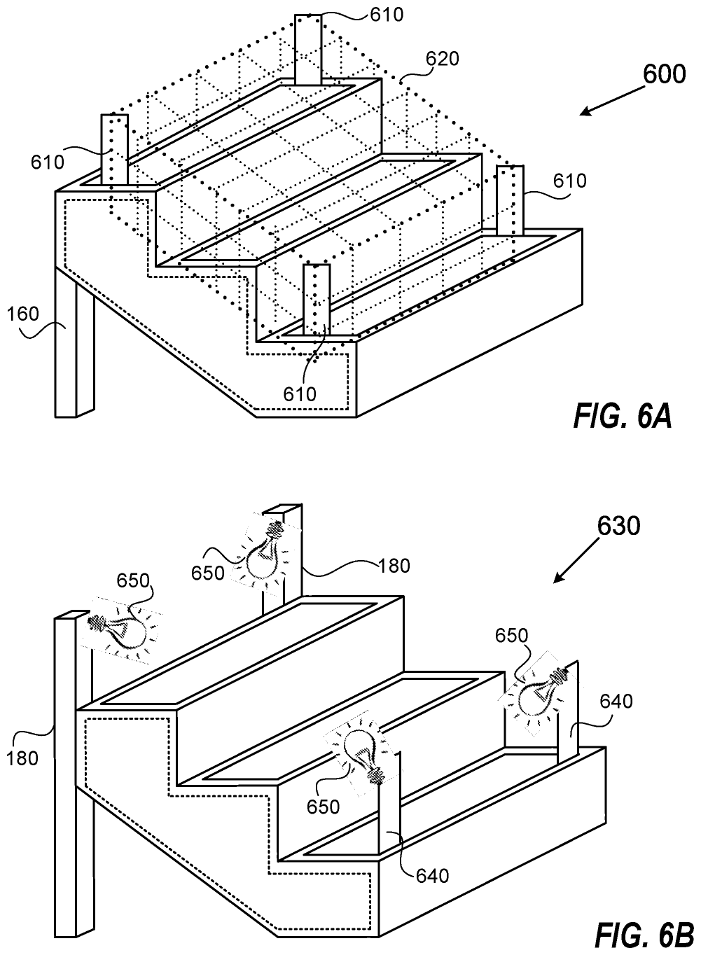

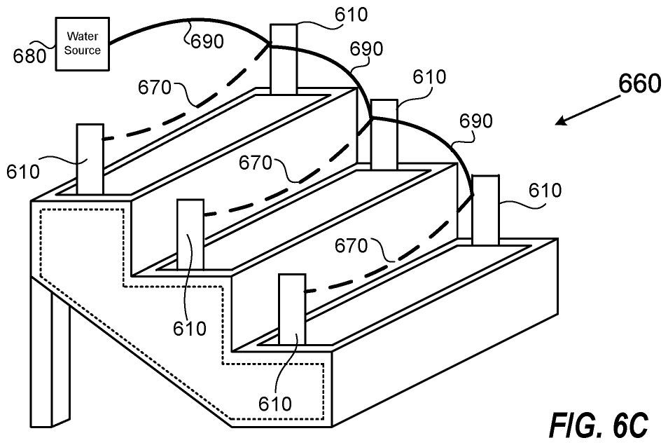

FIGS. 6A-C illustrate perspective views of several embodiments of an example integrated stair garden having posts or the like that extend above the steps. The stair gardens illustrated in FIGS. 6A-C are similar to those illustrated in FIGS. 1A-D so similar items are identified with same numbers, but not all items are identified for ease of illustration. The posts may be used to hang, for example, lights, netting, sensors, and watering devices. FIG. 6A illustrates an embodiment of a stair garden 600 where a post 610 is mounted to each side of the top and bottom step of the stair garden 600. The number and location of the posts 610 is in no way intended to be limited to the illustrated arrangement. The posts 610 may be designed so as to be secured to the stair garden 600 in some fashion. For example, the stair garden 600 may include slots and/or grooves (not illustrated) for the post to slide into. Alternatively, the stair garden 600 may include tabs and/or grooves and the posts 610 may include grooves and/or tabs that are used to secure the posts 610 to the stair garden. As illustrated, the posts 610 are connected to the side panels (240, 250 of FIG. 2). The posts 610 could be connected to any of the components of the stair garden 100 including, for example, the risers (210, 220, 230 of FIG. 2) or the back panel (280 of FIG. 2). The posts 610 may come at defined sizes and multiple posts may be connected together if, for example, additional height is required. The posts 610 may be designed to connect to one another (e.g., tongue and grove, tab and indent).

As illustrated, the posts 610 are utilized to hang a net 610 over the stair garden 600. For ease of illustration, the net 620 is shown extending across the top of the stair garden 600 by connecting to the tops of each of the posts 600 and then extending downward from the posts 610. The net 620 is in no way intended to be limited thereto. For example, the net 620 could cover only the top of the stair garden 600 (not extend downward from the posts 610) or cover only sections of the stair garden 600 without departing from the current scope. Likewise, the posts 610 need not be located at the corners of the net 620.

FIG. 6B illustrates an embodiment of a stair garden 630 where the legs 180 of the stair garden 630 extend above the steps and can be used to hang items therefrom. Additional posts 640 are mounted to each side of the bottom step of the stair garden 630. The number and location of the posts 640 is in no way intended to be limited to the illustrated arrangement. The posts 640 may be designed so as to be secured to the stair garden 630 in some fashion. As illustrated, the posts 640 are connected to the riser (210 of FIG. 2). The posts 640 could be connected to any of the components of the stair garden 630. As illustrated, the legs 180 and the posts 640 are utilized to hang lights 650 over the stair garden 630. The lights 650 are illustrated being mounted to the legs 180 and the posts 640 but are not limited thereto. Rather, strings of lights could be strung between the legs 180 and the posts 640 without departing from the current scope.

FIG. 6C illustrates an embodiment of a stair garden 660 where a post 610 is mounted to each side of each of the steps of the stair garden 660. The number and location of the posts 610 is in no way intended to be limited to the illustrated arrangement. As illustrated, the posts 610 are utilized to support perforated hoses 670 to enable water to exit therefrom to provide water to each of the planting sections (290, 292, 294 of FIG. 3) provided in each of the steps. The perforated hoses 670 could be replaced with perforated tubing, piping or the like or with hoses, tubing, piping or the like having sprinklers or the like mounted thereto, without departing from the current scope. The perforated hoses 640 may be connected to each other and a water source 680 using hoses 690 (that do not include holes). The hoses 690 could be replaced with tubing, piping or the like without departing from the current scope.

The number, arrangement and configuration of hoses 670, 690 is in no way intended to be limited to that illustrated. For example, each hose 670 could be individually connected to the water source 680 without departing from the current scope or hoses could be run vertically and/or diagonally in addition to or in place of the horizontally running hoses 670. In addition, various devices such as routers, shut-offs and/or flow controllers could be utilized in various manners, arrangements and configurations. The various devices may be manually operated or may be operated by a controller based on commands or based on different parameters determined (to be discussed in more detail later).

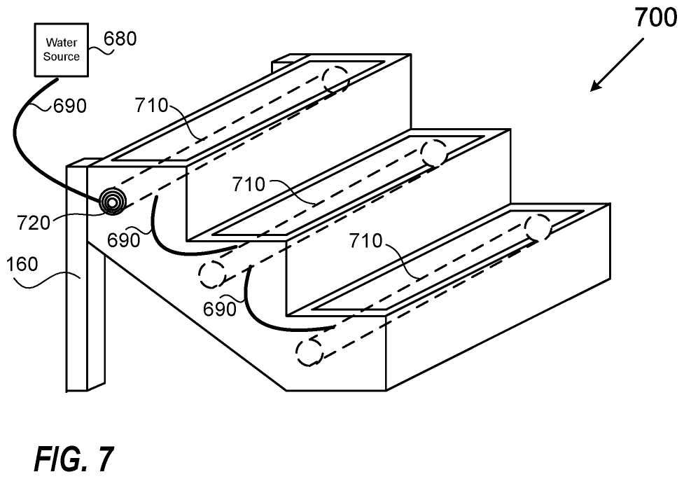

Rather than have the planting sections (290, 292, 294 of FIG. 3) provided in each of the steps watered from above as illustrated in FIG. 6C, the watering may occur from within the planting sections. FIG. 7 illustrates a perspective view of an example integrated stair garden 700 having watering enabled within the device. Each of the steps may be configured to support a perforated pipe 710 traversing therethrough. The perforated pipe 710 could be replaced with perforated hoses, tubing or the like without departing from the current scope. The side panels (240, 250 of FIG. 2) may be configured to support the perforated pipe 710. For example, an interior surface of each step may include a tab, ledge, pole or the like that the pipe 710 can receive, rest on, connect to, or the like. The perforated pipe 710 may be substantially the same length as the risers (210, 220, 230 of FIG. 2).

According to one embodiment, at least one of the side panels (240, 250 of FIG. 2) may include a spicket 720 formed therein for receiving a hose 690 from a water source 680. As illustrated, an upper step of the side panel facing out includes the spicket 720 and the spicket 720 is illustrated as a plurality of concentric circles to represent a threaded connecter for ease of illustration. The spicket 720 may connect to the perforated pipe 710 (perforated pipe 710 associated with upper step as illustrated) and provide the water thereto. According to one embodiment, the spicket 720 could be replaced by a hole for simply receiving the hose 690 rather than threading the hose 690 thereto. According to one embodiment, the hose 690 may connect direct to the perforated pipe 710 so that there would be no need for a spicket 720 or hole in the side panel. Hoses 690 may also be used to connect each of the perforated pipes 710. The hoses 690 could be replaced with tubing, piping or the like without departing from the current scope. The number and configuration of hoses 690 is in no way intended to be limited to the illustrated embodiment.

According to one embodiment, any of the various stair gardens illustrated may include wheels so that the stair garden could be moved. This would enable the stair garden to, for example, be moved inside during the winter. The wheels could be located along the bottom and be locked when the stair garden is to stay in a position and unlocked when movement is desired. The wheels could also be configured to be flipped up or removed when it is in a desired position and be flipped down or attached when the stair garden is to be moved.

According to one embodiment, any of the various stair gardens illustrated may include one or more sensors for measuring various parameters including, but not limited to, soil moisture, soil pH, lighting, plant growth, nutrient levels, temperature and humidity. The sensors may include memory for storing information gathered for retrieval. The sensors may include a wireless module (e.g., WiFi, Bluetooth) that enables wireless transmission of the information gathered to remote devices. Alternatively, the sensors may be connected to a separate wireless module that provides for wireless transmission of the information.

The information may be utilized to support the plants located in the stair planter. For example, if it is determined that the plants are dry they may be watered. According to one embodiment, a user may determine what steps to take based on the information provided. According to one embodiment, the information may be provided to an application running on a computing device and the computing device may recommend actions to be taken based thereon. The user may then take the recommended actions.

According to one embodiment, a user may manually take the necessary actions (e.g., watering the plants, providing plant food and/or nutrients). According to one embodiment, one more devices may be controllable and instructions may be provided remotely. For example, the hoses 640 or the perforated pipes 710 may include controllable valves that control the flow of water thereto. Instructions may cause the valves to turn on or off the flow of the water thereto. The instructions may be provided by a user via a remote computing device or the instructions may automatically be provided by a program or application running on the computing device.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. An integrated planter comprising
a plurality of steps, wherein each step includes a riser and a tread, wherein each of the plurality of treads includes an opening, wherein each opening creates a step planter;
a floor to seal off an underside of the integrated planter and provide a bottom for each of the plurality of step planters, wherein the floor is sloped from an upper step to a lower step; and
an integrated opening formed by the plurality of step planters, wherein each of the plurality of step planters is connected to at least one other step planter.

2. The integrated planter of claim 1, wherein the integrated opening is to hold soil.

3. The integrated planter of claim 2, wherein plants are to be planted in the plurality of step planters.

4. The integrated planter of claim 3, wherein the integrated opening provides for irrigation for each of the plurality of step planters.

5. The integrated planter of claim 3, wherein the integrated opening enables excess water to flow to the lower step.

6. The integrated planter of claim 1, further comprising one of more posts extending above the stair planters.

7. The integrated planter of claim 6, wherein the one or more posts are for hanging one of more of lights, netting, watering apparatus or tools.

8. The integrated planter of claim 1, further comprising one or more sensors, wherein the one or more sensors are to measure at least some subset of moisture, lighting, growth, temperature, humidity, pH, or nutrients.

9. The integrated planter of claim 8, further comprising a wireless interface to receive information from the one or more sensors and to provide the information to a remote wireless device.

10. The integrated planter of claim 1, further comprising one or more controllable devices including lights, watering means, and food means.

11. The integrated planter of claim 10, wherein instructions are provided to the one or more controllable devices via a remote wireless device.

12. An integrated planter comprising
a pair of side panels, wherein each side panel provides a plurality of steps along an upper edge and a sloped lower edge;
a plurality of risers to connect from a riser of a first of the pair of side panels to an appropriate riser of a second of the pair of side panels;
a sloped floor to seal off an underside of the integrated planter and connect to the sloped lower edge of each of the side panels; and
at least one post to secure an upper step of the integrated planter;
wherein a plurality of step planters are provided between each associated tread of the pair of side panels and abutting risers, an integrated opening is formed by the plurality of step planters, and each of the plurality of step planters is connected to at least one other step planter.

13. The integrated planter of claim 12, wherein
the integrated opening is to hold soil;
plants are to be planted in the plurality of step planters; and
the integrated opening provides for irrigation for each of the plurality of step planters as excess water from each of the plurality of step planters is to flow downward within the integrated opening.

14. The integrated planter of claim 12, further comprising
a back panel to connect from a back of a top riser of the first of the pair of side panels to a back of a top riser of the second of the pair of side panels; and
a bottom panel to connect from a bottom of a lower tread of the first of the pair of side panels to a bottom of a lower tread of the second of the pair of side panels;
wherein the sloped floor traverses from a bottom of the back panel to a back of the bottom panel.

15. The integrated planter of claim 12, further comprising one of more posts extending above the stair planters, wherein the one or more posts are for hanging one of more of lights, netting, watering apparatus or tools.

16. The integrated planter of claim 12, further comprising one or more sensors, wherein the one or more sensors are to measure at least some subset of moisture, lighting, growth, temperature, humidity, pH, or nutrients, wherein the one or more sensors are to provide information gathered to a remote wireless device.

17. The integrated planter of claim 12, further comprising one or more controllable devices including lights, watering means, and food means, wherein the one or more controllable devices are to receive instructions from a remote wireless device and take appropriate actions.

18. An integrated planter comprising
a pair of side panels, wherein each side panel provides a plurality of steps along an upper edge and a sloped lower edge;
a plurality of risers to connect from a riser of a first of the pair of side panels to an appropriate riser of a second of the pair of side panels;
a back panel to connect from a back of a top riser of the first of the pair of side panels to a back of a top riser of the second of the pair of side panels;
a bottom panel to connect from a bottom of a lower tread of the first of the pair of side panels to a bottom of a lower tread of the second of the pair of side panels;
a sloped floor to seal off an underside of the integrated planter and connect to the sloped lower edge of each of the side panels, wherein the sloped floor traverses from a bottom of the back panel to a back of the bottom panel;
one of more posts extending above the side panels and the risers, wherein the one or more posts are for hanging one of more of lights, netting, watering apparatus or tools; and
at least one post to secure an upper step of the integrated planter;
wherein a plurality of step planters are provided between each associated tread of the pair of side panels and abutting risers, an integrated opening is formed by the plurality of step planters, the integrated opening is to hold soil and plants are to be planted in the plurality of step planters.

19. The integrated planter of claim 18, further comprising one or more sensors, wherein the one or more sensors are to measure at least some subset of moisture, lighting, growth, temperature, humidity, pH, or nutrients, wherein the one or more sensors are to provide information gathered to a remote wireless device.

20. The integrated planter of claim 18, further comprising one or more controllable devices including lights, watering means, and food means, wherein the one or more controllable devices are to receive instructions from a remote wireless device and take appropriate actions.
